(19) United States
(12) Patent Application Publication
(10) Pub. No.: US 2005/0066371 A1
(43) Pub. Date: Mar. 24, 2005

(54) Mobile digital security system and method

(76) Inventor: Bin Lu, Santa Clara, CA (US)

Correspondence Address: FORTUNE LAW GROUP, Suite 315, 100 Century Center Court, San Jose, CA, 95112, US

(21) Appl. No.: 10/666,344

(22) Filed: Sep. 19, 2003

(51) Int. Cl. H04N 7/173

(52) U.S. Cl. 725/105

(57) ABSTRACT

A mobile digital security system includes a digital video recorder disposed in each of at least one mobile unit and operable to generate a digital video/data signal, a wireless interface coupled to the digital video recorder for encapsulating and transmitting the digital video/data signal, a wireless device coupled to the wireless interface through a wireless network for receiving the encapsulated and transmitted digital video/data signal, and a server for processing the received digital video/data signal.

### BACKGROUND OF THE INVENTION

The present invention generally relates to surveillance systems and more particularly to a mobile digital security system including a plurality of mobile units coupled through a wireless network to a central station having an archiving server.

Increasingly, surveillance systems have been employed in mobile units such as law enforcement patrol cars, commercial and military armored vehicles, school buses, trucks and aviation equipment. These systems observe and record activity both within the mobile units as well as activity occurring outside the mobile units. The recorded activity may then be used for various purposes including as evidence in the prosecution of wrongdoers.

Prior art mobile surveillance systems suffer the disadvantage of being difficult to implement and manage. While it is known to transmit video images to a location away from the mobile unit, the prior art systems make no provision for the management of the transmitted video.

It is well known in the art to use vehicle mounted video cameras to record internal and external activity. U.S. Pat. No. 6,212,907 entitled “Secure, Vehicle Mounted, Surveillance System” discloses a system having a video camera for generating video signals of an incident proximate the vehicle, having an audio device for monitoring events proximate the vehicle, motion sensor to activate the system and lights activated by the system to illuminate the area viewed by the camera. The video signals are digitized into a synchronized data file, carrying a unique vehicle identification and a time indicator with other input data occurring on or a bout the vehicle such as audio recordings and the like. The file is encrypted and stored on a large capacity, code accessible device or transmitted, via a transceiver, real time to authorities and/or an off vehicle storage site. The transceiver employs a satellite communication link.

U.S. Pat. No. 6,262,764 entitled “Vehicle Surveillance System Incorporating Remote and Video Data Input” discloses a system including a first camera mounted on a dash of a police vehicle and a second camera mounted on a portable structure such as a clipboard. A telemetry link from the clipboard to the vehicle is established for transmitting video data to and from the police officer on foot out of the vehicle and a digital data transmission link is established with various input and output devices on the clipboard. At the vehicle, one or more images are recorded on a VCR and video and digital data can be transmitted from the vehicle to a remote site for communication with a remotely located police computer or other data base.

As can be seen, the prior art discloses systems capable of recording and transmitting video images from a vehicle. There remains a need however for a mobile digital security system including a plurality of mobile units coupled through a wireless network to a central station having an archiving server. The wireless network is preferably a commonly employed network. Further, the archiving server preferably provides for management of the mobile digital surveillance system.

### SUMMARY OF THE INVENTION

In accordance with one aspect of the invention, a mobile digital security system includes a digital video recorder disposed in each of at least one mobile unit and operable to generate a digital video/data signal, a wireless interface coupled to the digital video recorder for encapsulating and transmitting the digital video/data signal, a wireless device coupled to the wireless interface through a wireless network for receiving the encapsulated and transmitted digital video/data signal, and a server for processing the received digital video/data signal.

In accordance with another aspect of the invention, a method of providing mobile digital security includes the steps of collecting digital video/data at a mobile unit, encoding and transmitting the digital video/data, receiving the encoded and transmitted digital video/data, and processing the received digital video/data.

These and other features, aspects and advantages of the present invention will become better understood with reference to the following drawings, description and claims.

### BRIEF DESCRIPTION OF THE DRAWINGS

FIG. 1 is a schematic representation of a mobile digital security system in accordance with the present invention; and

FIG. 2 is a flow diagram of a method of providing mobile digital security in accordance with the present invention.

### DETAILED DESCRIPTION OF THE INVENTION

The following detailed description is of the best modes of carrying out the invention. The description is not to be taken in a limiting sense, but is made merely for the purpose of illustrating the general principles of the invention, since the scope of the invention is best defined by the appended claims.

The present invention generally provides a mobile digital security system including a plurality of mobile units coupled through a wireless network such as a PCP/IP network to a central station having an archiving server. A digital video recorder may be disposed in each of the plurality of mobile units, the digital video recorder being adapted to record digital video together with other data. Such other data may include a digital water mark to provide for authentication, time data and event data. The archiving server may provide for real time dynamic synchronization between each of the digital video recorders and the archiving server over the wireless network.

In an exemplary system, a plurality of police patrol cars may each be equipped with a digital video recorder for recording digital video/data. Each digital video recorder may include a network interface, such as the IEEE 802.11b interface, for communicating the digital video/data to the archiving server. The archiving server may be located in a police station to provide police authorities with remote management and control capabilities over the digital video recorders.

The 802.11b standard specifies a wireless local area network (WLAN) providing mobile users with Ethernet levels of performance, through-put, and availability. A WLAN provides a data transmission system designed to provide location-independent network access between computing devices by using radio waves rather than a cable infrastructure. A WLAN further provides for wireless access by a group of mobile users to resources and services of a resource on a wired network.

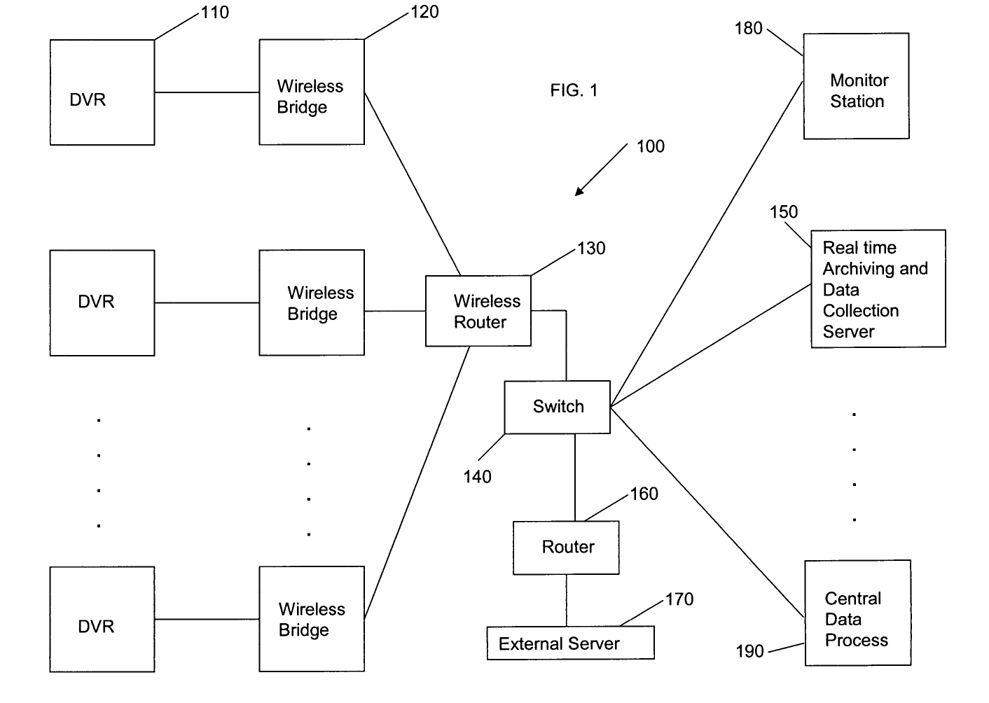

With reference to FIG. 1, a mobile digital security system generally designated 100 may include a plurality of digital video recorders 110, each digital video recorder 110 coupled to a wireless bridge 120. Wireless bridges 120 may be coupled to a wireless router 130 for digital transmission to a wireless switch 140 which may be located in a structure such as a police station (not shown).

Mobile digital security system 100 may further include a real time archiving and data collection server 150 coupled to the wireless switch 140. Server 150 provides for management of video and data as described herein. A router 160 coupled to an external server 170 as well as a monitor station 180 and a central data process 190 may be coupled to the wireless switch 140.

Mobile digital security system 100 may be implemented in many different forms and configurations using various types and combinations of components to provide a variety of features and functions within the scope of the invention. For clarity, the invention will be described herein primarily in the context of one particular exemplary embodiment. However, it will be understood that the scope of the invention is not limited to the particular embodiment described, but rather extends to all such embodiments, forms, configurations, types and combinations.

Digital video recorder 110 is preferably a Model DV6010 Digital Video Recorder manufactured by Aegison Corp. of Santa Clara, Calif. Digital video recorder 110 preferably provides for full frame rate recording and network streaming. A camera (not shown) may be coupled to the digital video recorder 110 to provide an analog video signal to the digital video recorder 110. In addition, an alarm or motion detection device (not shown) and a siren or bell (not shown) may be coupled to the digital video recorder 110. Digital video recorder 110 may also include a hard disk or other digital media storage device (not shown).

Digital video recorder 110 may include a stand alone non-PC embedded system for providing stability and high quality MPEG2 video recording and playback at full frame rate of 30 frames per second. Digital video recorder 110 further may provide for duplex digital video operation including simultaneous real time 30 frames per second recording and 30 frames per second playback.

A digital watermark may be added to the video/data recorded by each digital video recorder 110 to authenticate the video/data.

Digital video recorder 110 further may include a high quality audio input (32 KHz) for monitoring, recording, playback, and remote monitoring. In recording mode, each digital video recorder 110 may provide alternatively for alarm event recording, motion event recording, scheduled recording, and instant recording. Further, each digital video recorder 110 may provide for video loss detection with alarm and pre-alarm recording.

Each digital video recorder 110 may include motion detection with a customizable detecting area and sensitivity. Digital video recorder 110 may further include three levels of secure authentication for remote access. Each digital video recorder 110 may be remotely upgradeable and configurable. Each digital video recorder 110 may also be remotely backed up.

Each digital video recorder 110 may be coupled to each wireless bridge 120 by means of an Ethernet interface or connector (not shown). Each wireless bridge 120 includes functionality to couple each Ethernet interface to the wireless router 130. Wireless router 130 includes functionality to transmit digital video/data from each of the plurality of digital video recorders 110 to wireless switch 140.

The real time archiving and data collection server 150 may include the Model SAS1000 Streaming & Archiving Server manufactured by Aegison Corporation of Santa Clara, Calif. Server 150 may be operable to control and manage up to 256 digital video recorders 110 providing a real time streaming gateway for multiple digital video recorder nodes. Real time remote backup may be provided at a variable frame rate of one-half frame per second to 30 frames per second. Server 150 advantageously provides for post recording backup in a case where a vehicle including a digital video recorder 110 moves a sufficient distance away from the wireless switch 140 or in a case of connection or electrical failure.

Server 150 may be operable to provide a log system for tracking any event or access to the server 150 itself or any of the plurality of digital video recorders 110. Other management features may include HTML based configuration with password authentication, triplex working mode for real time backup, real time monitoring and playback, event triggering macro for sending email or a short message, HTTP/RTSP or other IP based streaming module providing reliable and easy streaming to any remote viewing personal computer which may be coupled to external server 170, time search and event search queue management, digital right management module for playback authentication, and interface for a third party processing server such as a face recognition server. Server 150 further may include a real time synchronization protocol for alerting the monitoring station 180 when one of the plurality of digital video recorders 110 is proximate the station and the status of the digital video recorder 110.

Central data process 190 may include functionality to manage both external data and internal data by external and internal data processes respectively. Such external and internal data may be managed in a database. External data processes may include data synchronization from each digital video recorder 110 in either pull mode (since each digital video recorder 110 may include compact HTTP/RTSP server functionality) or in listen mode in which each digital video recorder 110 may be sending video/data to the central data process 190. The data synchronization may include keeping status data on each digital video recorder 110 such as a location of the digital video recorder 110 in a police patrol car for example. The location may be determined by analyzing an IP packet received from the digital video recorder 110 to determine a router/gateway from which the IP packet was received.

External data may also include video content of each digital video recorder 110. Central data process 190 may include functionality to initiate a remote retrieve function to detect the presence of new video data in each digital video recorder 110 by, for example, checking each digital video recorder's 110 recording history. External data may further include a record of where the digital video recorder 110 has been, where the record may be determined by an analysis of GPS data recorded by each digital video recorder. External data may also include log data and event data recorded by each digital video recorder 110 and stored in server 150.

Central data process 190 may also include internal data processes. Internal data may include an index of all digital video recorder 110 data received by server 150. Internal data processes may also include a process for destroying received data from each digital video recorder 110 after three months as required by some police jurisdictions. Internal data processes may include functionality to create a plurality of reports for use by management personnel such as reports related to a particular police officer, a particular patrol car, and a particular event.

Internal data processes may also include authentication processes for checking the authority of users to access data stored in server 150. Internal data processes include processes for providing data to authorized users including video/data easily viewable or downloadable to monitor station 180 and external server 170 for example.

As will be appreciated by those skilled in the art, central data process 190 may be a process running on server 150.

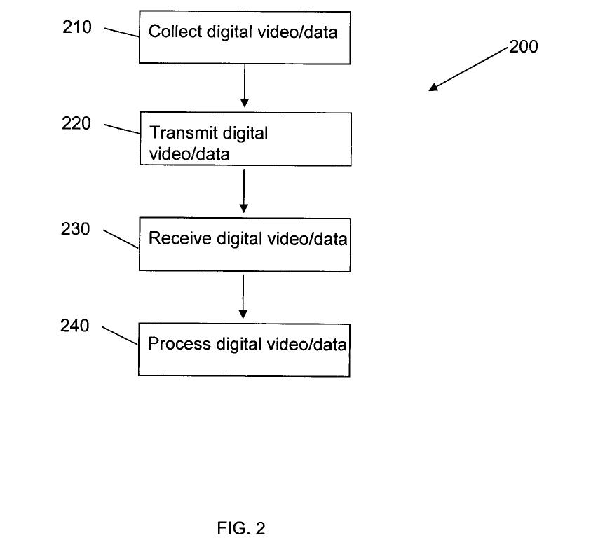

With reference to FIG. 2, a method of providing mobile digital security 200 includes the step 210 of collecting digital video/data from the digital video cameras 110. In a step 220, the collected digital video/data may be transmitted through a wireless network and received in a step 230. Finally in a step 240, the received digital video/data may be processed by server 150.

The mobile digital security system 100 has been generally described for use in law enforcement patrol cars. However, it will be appreciated that system 100 may also be used in a variety of other environments including commercial and military armored vehicles, school buses, trucks and aviation equipment. Therefore it will be understood that the description encompasses mobile digital security systems for use in all such environments.

It should be understood, of course, that the foregoing relates to preferred embodiments of the invention and that modifications may be made without departing from the spirit and scope of the invention as set forth in the following claims.

1. A mobile digital security system comprising:
a digital video recorder disposed in each of at least one mobile unit and operable to generate a digital video/data signal;
a wireless interface coupled to the digital video recorder for encapsulating and transmitting the digital video/data signal;
a wireless device coupled to the wireless interface through a wireless network for receiving the encapsulated and transmitted digital video/data signal; and
a server for processing the received digital video/data signal.

2. The mobile digital security system of claim 1, wherein the wireless network is a TCP/IP based network.

3. The mobile digital security system of claim 2, wherein the wireless network is a 802.11b wireless WLAN.

4. The mobile digital security system of claim 1, wherein the server is operable to communicate with the digital video recorder.

5. The mobile digital security system of claim 1, wherein the mobile unit is a police vehicle and the server is disposed in a police station.

6. The mobile digital security system of claim 1, wherein the server is operable to provide remote video/data management.

7. The mobile digital security system of claim 1, wherein the server is operable to provide a real time streaming gateway to a plurality of digital video recorders.

8. The mobile digital security system of claim 1, wherein the server is operable to provide remote real time backup at a variable frame rate.

9. The mobile digital security system of claim 8, wherein the variable frame rate comprises a frame rate from one-half frame per second to thirty frames per second.

10. The mobile digital security system of claim 1, wherein the server is operable to provide post recording backup.

11. The mobile digital security system of claim 1, wherein the server is operable to provide a log system for tracking an event.

12. The mobile digital security system of claim 1, wherein the server is operable to provide a log system for tracking an access to the server.

13. The mobile digital security system of claim 1, wherein the server is operable to provide HTML based configuration with password authentication.

14. The mobile digital security system of claim 1, wherein the server is operable to provide triplex real time backup.

15. The mobile digital security system of claim 1, wherein the server is operable to provide real time monitoring.

16. The mobile digital security system of claim 1, wherein the server is operable to provide playback.

17. The mobile digital security system of claim 1, further comprising a remote viewing device coupled to the server.

18. The mobile digital security system of claim 17, wherein the server comprises an IP based streaming module operable to provide digital video/data to the remote viewing device.

19. The mobile digital security system of claim 1, wherein the server comprises an event triggering macro operable to send data to the digital video recorder.

20. The mobile digital security system of claim 1, wherein the server is operable to provide time and event search queue management.

21. The mobile digital security system of claim 1, wherein the server comprises a digital right management module operable to provide playback authentication.

22. The mobile digital security system of claim 1, further comprising a monitoring station.

23. The mobile digital security system of claim 22, wherein the server comprises a protocol for real time synchronization between the monitoring station and the digital video recorder.

24. The mobile digital security system of claim 1, wherein the server is operable to provide data synchronization in a database.

25. A method of providing mobile digital security comprising the steps of:
generating digital video/data at a mobile unit;
encapsulating and transmitting the digital video/data;
receiving the encapsulated and transmitted digital video/data; and
processing the received digital video/data.

26. The method of providing mobile digital security of claim 25, wherein the digital video/data is generated by a digital video recorder.

27. The method of providing mobile digital security of claim 26, further comprising the step of transmitting digital control data to the digital video recorder over an IP network.

28. The method of providing mobile digital security of claim 25, wherein the digital video/data is stored in a digital storage media.

29. The method of providing mobile digital security of claim 25, wherein the digital video/data is transmitted over a wireless TCP/IP based network.

30. The method of providing mobile digital security of claim 25, wherein the digital video/data is processed by a server.

31. The method of providing mobile digital security of claim 30, wherein the digital video/data is synchronized with a server database in real time.

32. The method of providing mobile digital security of claim 31, wherein the synchronized digital video/data is accessible at standard interfaces to remote clients.

33. The method of providing mobile digital security of claim 25, further comprising the step of providing encrypted password authentication before encapsulating and transmitting the digital video/data to a server.

34. The method of providing mobile digital security of claim 25, further comprising the step of transmitting the processed digital video/data to a remote client over an IP network.
